(19) United States
(12) Patent Application Publication
(10) Pub. No.: US 2013/0343269 A1
(43) Pub. Date: Dec. 26, 2013

(54) ROUTING DATA OVER A NON-3RD GENERATION PARTNERSHIP PROJECT TRUSTED NETWORK

(71) Applicant: TELEFONAKTIEBOLAGET L M ERICSSON (PUBL), Stockholm (SE)

(72) Inventors: Paul J. EVANS, Montreal (CA); Zu QIANG, Kirkland (CA)

(73) Assignee: Telefonaktiebolaget L M Ericsson (Publ), Stockholm (SE)

(21) Appl. No.: 13/851,276

(22) Filed: Mar. 27, 2013

Related U.S. Application Data
(60) Provisional application No. 61/662,544, filed on Jun. 21, 2012.

(51) Int. Cl. H04W 40/02

(52) U.S. Cl. CPC H04W 40/02
USPC 370/328

(57) ABSTRACT

A method and system for routing a packet in a non 3rd Generation Partnership Project (“3GPP”) network are provided. In accordance with one aspect, a method includes receiving via a first type interface a 3GPP Policy and Charging Control (“PCC”) rule. The 3GPP PCC rule is evaluated. A local rule associated with the 3GPP PCC rule is determined. The packet is routed on the non-3GPP network to a user equipment using the determined local rule.

### CROSS-REFERENCE TO RELATED APPLICATION

This application is related to and claims priority to U.S. Provisional Application Ser. No. 61/662,544, filed Jun. 21, 2012, entitled “Method and System for Applying Policy Changing Control and Quality of Service on a S2a-GTP Tunnel over Trusted WLAN” the entirety of which is incorporated herein by reference.

### TECHNICAL FIELD

The present invention relates to a method and system for routing a packet in a non 3rd Generation Partnership Project network.

### BACKGROUND

As 3rd Generation Partnership Project (“3GPP”) User Equipment (“UE”) devices move between a 3GPP Mobile Network and a fixed broadband network, the interworking between next generation fixed and 3GPP wireless networks, as well as how to define the interworking reference architectures to support these use cases and business requirements, has become an issue of interest. With the introduction of Internet Protocol (“IP”) enabled mobile devices, a potential commonality of network technology between wireless and wireline service delivery has emerged. The services being offered have become less dependent on the type of access network, i.e., fixed or wireless, and are now focused on getting connectivity regardless of the access type.

This fixed mobile convergence trend is impacting telecommunication and information industries, i.e., service providers, who aim to provide subscribers with access to services anywhere anytime, regardless of the access network type to which the subscribers are connected. Fixed mobile convergence generally refers to permitting a subscriber to access services over fixed and wireless networks. The fixed mobile convergence architecture needs to support service providers offering both fixed network access and 3GPP wireless access network, as well as separate access providers offering either fixed or 3GPP wireless access types and offering the other access type in conjunction with another provider.

Service providers of non-3GPP networks lack the ability to adjust policies and Quality of Service offered in non-3GPP networks when routing communication sessions across 3GPP networks.

### SUMMARY

The present invention advantageously provides a method and system for routing a packet in a non-3GPP network. In accordance with one embodiment, a method for routing a packet in a non 3rd Generation Partnership Project (“3GPP”) network. The method includes receiving via a first type interface a 3GPP Policy and Charging Control (“PCC”) rule. The 3GPP PCC rule is evaluated. A local rule associated with the 3GPP PCC rule is determined. The packet is routed on the non-3GPP network to a user equipment using the determined local rule.

In accordance with an aspect of this embodiment, the non-3GPP network is a Broadband Forum (“BBF network”), the first type interface is an S2a interface and the local rule is a BBF local rule. Routing the packet further includes applying the BBF local rule associated with the 3GPP PCC rule. In accordance with another aspect of this embodiment, a mapping table mapping the received 3GPP PCC rule to the BBF local rule is generated and stored. In accordance with an aspect of this embodiment, the BBF local rule mapped to the 3GPP PCC rule in the mapping table is determined, and applying the BBF local rule associated with the 3GPP PCC rule includes applying the determined BBF local rule. In accordance with still another aspect of this embodiment, the 3GPP PCC rule is a 3GPP PCC Quality of Service, (“QoS”), rule, and the mapping table is stored in at least one of a Broadband Policy Control Framework (“BPCF”) computer, a Trusted Wireless Access Gateway (“TWAG”) computer, and a Border Network Gateway Policy Enforcement Point (“BNG/PEP”) computer. In accordance with an aspect of this embodiment, the receiving and applying is performed by a Trusted Wireless Local Area Network Access Network (“TWAN”) computer, the TWAN computer being one of a Broadband Policy Control Framework (“BPCF”) computer, a Trusted Wireless Access Gateway (“TWAG”) computer and a Border Network Gateway Policy Enforcement Point (“BNG/PEP”) computer. In accordance with an aspect of this embodiment, a determination is made as to whether the 3GPP PCC rule can be applied in the BBF network. If it is determined that the 3GPP PCC rule can be applied in the BBF network, then a determination is made as to whether the 3GPP PCC rule needs to be modified and to be implemented in the BBF network. If it is determined that the 3GPP PCC rule needs to be modified, then the BBF local rule associated with the 3GPP PCC rule is determined. Applying the BBF local rule further includes applying the BBF local rule associated with the 3GPP PCC rule. Else, if it is determined that the 3GPP PCC rule cannot be applied in a BBF network, then the 3GPP PCC rule is ignored. In accordance with an aspect of this embodiment, the 3GPP PCC rule includes one of a Quality of Service (“QoS”) Class Identifier (“QCI”) value, an Allocation and Retention Policy (“ARP”) value, a Guaranteed Bit Rate (“GBR”) value, a Maximum Bit Rate (“MBR”) value, an event trigger and a charging rule. In accordance with another aspect of this embodiment, the received 3GPP PCC rule is forwarded to a Broadband Policy Control Framework (“BPCF”) computer for one of verification and authorization of the 3GPP PCC rule based on a BBF policy. In accordance with still another aspect of this embodiment, receiving, via the S2a interface, further includes receiving the 3GPP PCC rule from a 3GPP computer, and the method further includes receiving from a Policy and Charging Rules Function (“PCRF”) computer via an S9a interface, the 3GPP PCC rule.

In accordance with another embodiment, a Trusted Wireless Local Area Network Access Network (“TWAN”) computer in a non 3rd Generation Partnership Project (“3GPP”) network is provided. The TWAN computer includes a receiver configured to receive, via a first type interface, a 3GPP Policy and Charging Control (“PCC”) rule. The TWAN computer further includes a processor in communication with the receiver, the processor is configured to: evaluate the 3GPP PCC rule; determine a local rule associated with the 3GPP PCC rule; and route the packet on the non-3GPP network to a user equipment using the determined local rule. In accordance with an aspect of this embodiment, the non-3GPP network is a Broadband Forum (“BBF”) network, the first type interface is an S2a-GTP interface, the local rule is a BBF local rule, and the processor is further configured to apply the BBF local rule associated with the 3GPP PCC rule to route the packet to the user equipment.

In accordance with another aspect of this embodiment, the processor is further configured to route a plurality of packets on the non-3GPP network from the user equipment using the BBF local rule; and generate a mapping table mapping the received 3GPP PCC rule to the BBF local rule. The TWAN computer further has a memory in communication with the receiver and the processor, the memory being configured to store the mapping table.

In accordance with still another aspect of this embodiment, the processor is further configured to determine the BBF local rule mapped to the 3GPP PCC rule in the mapping table; and the processor applying the BBF local rule associated with the 3GPP PCC rule includes the processor applying the determined BBF local rule to route the packet to the user equipment. In accordance with an aspect of this embodiment, the 3GPP PCC rule is a 3GPP PCC Quality of Service (“QoS”) rule, and the TWAN computer is one of a Broadband Policy Control Framework (“BPCF”) computer, a Trusted Wireless Access Gateway (“TWAG”) computer and a Border Network Gateway Policy Enforcement Point (“BNG/PEP”) computer. In accordance with an aspect of this embodiment, the processor is further configured to determine whether the 3GPP PCC rule can be applied in the BBF network; and if the processor determines that the 3GPP PCC rule can be applied in the BBF network, then the processor is further configured to determine whether the 3GPP PCC rule needs to be modified in order to be implemented in the BBF network. If the processor determines that the 3GPP PCC rule needs to be modified, then the processor is further configured to determine the BBF local rule associated with the 3GPP PCC rule. The processor applying the BBF local rule further includes the processor applying the BBF local rule associated with the 3GPP PCC rule. Else, if the processor determines that the 3GPP PCC rule cannot be applied in the BBF network, then the processor is further configured to ignore the 3GPP PCC rule, and determine whether an applicable local BBF rule may be applied. If the processor determines that an applicable local BBF rule may be applied, then the processor is further configured to apply the applicable local BBF rule.

In accordance with another aspect of this embodiment, the TWAN computer further includes a transmitter in communication with the receiver and the processor. The transmitter is configured to forward the received 3GPP PCC rule to a Broadband Policy Control Framework, BPCF, computer for one of verification and authorization of the 3GPP PCC rule based on BBF policy. In accordance with still another aspect of this embodiment, the receiver is further configured to receive the 3GPP PCC rule from a 3GPP computer; and receive from a Broadband Policy Control Framework (“BPCF”) computer the 3GPP PCC rule.

According to another embodiment, a Broadband Forum (“BBF”) system is provided. The BBF system includes a Trusted Wireless Local Area Network Access Network (“TWAN”) computer. The TWAN computer includes a TWAN receiver configured to receive via a first type interface from a 3rd Generation Partnership Project (“3GPP”) Packet Data Network Gateway (“PDN GW”) computer, a 3GPP Policy and Charging Control (“PCC”) Quality of Service (“QoS”) rule. The TWAN computer further includes a TWAN processor in communication with the TWAN receiver. The TWAN processor is configured to: evaluate the 3GPP PCC QoS rule; determine a BBF local rule associated with the 3GPP PCC QoS rule; and route the packet on the non-3GPP network to a user equipment using the determined BBF local rule. In accordance with an aspect of this embodiment, the first type interface is an S2a interface. The TWAN processor is further configured to apply the BBF local rule associated with the 3GPP PCC QoS rule to route the packet to the user equipment; and generate a mapping table mapping the received 3GPP PCC QoS rule to the BBF local rule. The TWAN computer further includes a TWAN memory in communication with the TWAN receiver and the TWAN processor. The TWAN memory is configured to store the mapping table.

In accordance with an aspect of this embodiment, the TWAN processor is further configured to determine the BBF local rule mapped to the 3GPP PCC QoS rule in the mapping table. The processor applying the BBF local rule associated with the 3GPP PCC QoS rule includes the processor applying the determined BBF local rule when routing the packet to the user equipment. In accordance with another aspect of this embodiment, the BBF system further includes a Broadband Policy Control Framework (“BPCF”) computer configured to communicate with the TWAN computer. The BPCF computer includes a BPCF receiver configured to receive from a Policy Charging and Rules Function (“PCRF”) computer via a second type interface, the 3GPP PCC QoS rule. The BPCF computer further includes a BPCF processor in communication with the BPCF receiver. The BPCF processor is configured to generate a mapping table mapping the received 3GPP PCC QoS rule to the BBF local rule. The BPCF computer further includes a BPCF memory in communication with the BPCF receiver and the BPCF processor, the BPCF memory being configured to store the mapping table.

In accordance with still another aspect of this embodiment, the TWAN computer further includes a TWAN transmitter in communication with the TWAN receiver and the TWAN processor. The TWAN transmitter is configured to send a query to a Broadband Policy Control Framework, (“BPCF”) computer. The TWAN receiver is further configured to receive a query response from the BPCF computer. The TWAN processor is further configured to determine, based at least in part on the query response, whether the 3GPP PCC QoS rule needs to be modified in order to be implemented in a BBF network. If the TWAN processor determines that the 3GPP PCC QoS rule needs to be modified, then the TWAN processor is further configured to determine the BBF local rule associated with the 3GPP PCC QoS rule. Else, if the TWAN processor determines that the 3GPP PCC QoS rule cannot be applied in the BBF network, then the TWAN processor is further configured to ignore the 3GPP PCC QoS rule. In accordance with still another aspect of this embodiment, the BBF system further includes a Broadband Policy Control Framework (“BPCF”) computer. The BPCF computer is configured to communicate with the TWAN computer. The TWAN computer further includes a TWAN transmitter in communication with the TWAN receiver and the TWAN processor, the TWAN transmitter configured to transmit the received 3GPP PCC QoS rule to the BPCF computer for one of verification and authorization of the 3GPP PCC QoS rule based on a BBF policy.

In accordance with still another aspect of this embodiment the second type interface is an S9 interface, the TWAN computer is one of a Trusted Wireless Access Gateway (“TWAG”) computer and a Border Network Gateway Policy Enforcement Point (“BNG/PEP”) computer. The BPCF computer includes: a BPCF processor configured to verify the 3GPP PCC QoS rule based at least in part on the BBF policy; and a BBF transmitter, the BBF transmitter configured to transmit to the TWAN computer at least one of an authorized 3GPP PCC QoS rule, event trigger and charging rule.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a diagram of an exemplary system for interworking a 3GPP network and a non-3GPP network constructed in accordance with the principles of the present invention;

FIG. 2 is a block diagram of another exemplary system for interworking a 3GPP network and a non-3GPP network constructed in accordance with the principles of the present invention;

FIG. 3 is a block diagram of an exemplary computer constructed in accordance with the principles of the present invention;

FIG. 4 is a block diagram of an exemplary mapping table constructed in accordance with the principles of the present invention;

FIG. 5 is a flowchart of an exemplary process for routing a packet between a 3GPP network and a non-3GPP network, in accordance with the principles of the present invention;

FIG. 6 is a flowchart of an exemplary process for generating and storing a mapping table, in accordance with the principles of the present invention;

FIG. 7 is a flowchart of an exemplary process for routing a packet in non-3GPP network, in accordance with the principles of the present invention; and

FIG. 8 is a flowchart of another exemplary process for generating a mapping table, in accordance with the principles of the present invention.

### DETAILED DESCRIPTION

Embodiments of the present invention provide a method, system and Trusted Wireless Local Area Network Access Network (“TWAN”) computer for routing a packet in a non 3rd Generation Partnership Project (“3GPP”) network. The method includes receiving, via a first type interface, a 3GPP Policy and Charging Control (“PCC”) rule. The 3GPP PCC rule is evaluated. A local rule associated with the 3GPP PCC rule is determined. The packet is routed on the non-3GPP network to a user equipment using the determined local rule.

Before describing in detail exemplary embodiments that are in accordance with the present invention, it is noted that the embodiments reside primarily in combinations of apparatus components and processing steps related to implementing a method, a system and a TWAN computer for routing a packet in a non-3GPP network. Accordingly, the method, system, and TWAN computer components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein. Of note, although embodiments are described with reference to communication from a 3GPP network to a user device on a non-3GPP network, this is done for ease of explanation. It is understood that the principles described herein are applicable to communications from a user device as well.

As used herein, relational terms, such as “first” and “second,” “top” and “bottom,” and the like, may be used solely to distinguish one entity or element from another entity or element without necessarily requiring or implying any physical or logical relationship or order between such entities or elements.

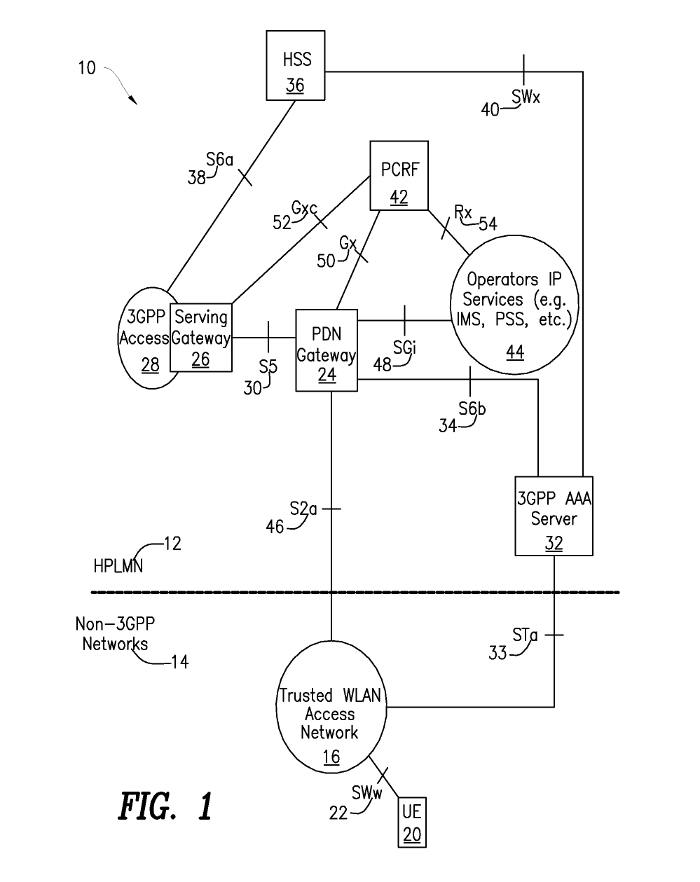

Referring now to the drawing figures in which reference designators refer to like elements, there is shown in FIG. 1 a diagram of an exemplary system constructed in accordance with the principles of the present invention and designated generally as “10”. System 10 is an interworking architecture for routing packets between 3GPP network 12 and non-3GPP network 14. 3GPP network 12 may be a Home Public Land Mobile Network (“HPLMN”) network. Non-3GPP network 14 may be any type of non-3GPP network, such as a Broadband Forum (“BBF”) network which includes, for example, a Trusted Wireless Local Area Network Access Network (“TWAN”) 16. TWAN 16 is in communication with a User Equipment (“UE”) 20 via an interface, such as SWw interface 22. 3GPP network 12 may include, among different components and entities, Packet Data Network Gateway (“PDN GW”) 24, Serving Gateway 26, 3GPP access 28, 3GPP Authorization and Authentication (“AAA”) server 32, Home Subscriber Service (“HSS”) entity 36, Policy and Charging Rules Function (“PCRF”) 42, and Operator's IP Services server 44.

PDN GW 24 is the point of interconnect between the Evolved Packet Core (“EPC”), i.e., the core network of the LTE system, and external IP networks, also referred to as a packet data networks (“PDNs”). TWAN 16 is an exemplary external network. PDN GW 24 is configured to route packets to and from PDNs, such as TWAN 16. PDN GW 24 also performs various functions including IP address, IP prefix allocation, policy control and charging. PDN GW 24 is in communication with entities in 3GPP network 12 via different interfaces. For example, PDN GW 24 is in communication with TWAN 16 via S2a interface 46; with 3GPP AAA Server 32 via S6b interface 34; with Operator's IP Services server 44 via SGi interface 48; with PCRF 42 via Gx interface 50; and with Serving Gateway 26 via S5 interface 30. Of note, while specific interfaces are described, the invention is not limited to such, as the different entities may communicate with each other and other entities using any suitable interface.

Serving Gateway 26 transports IP data traffic between UE 20 and external networks, such as TWAN 16. As such, Serving Gateway 26 serves UE 20 by routing the incoming and outgoing IP packets. Serving Gateway 26 acts as an anchor point for intra-LTE mobility, for example, in cases of handover between Evolved Nodes B (“eNodeBs”), e.g., base stations, and other 3GPP accesses 28. 3GPP access 28 may be a base station that provides 3GPP radio access to UE 20. Serving Gateway 26 is logically connected to the other gateway, PDN GW 24 via interface S5 30. Serving Gateway 26 also communicates with PCRP 42 via an interface, such as Gxc interface 52. Serving Gateway 26 is also in communication with 3GPP access 28.

3GPP AAA server 32 provides support for non-3GPP access users with services like authentication, authorization and location management servers. 3GPP AAA server 32 stores user related information that is used to grant access to non-3GPP access. 3GPP AAA server 32 coordinates the information used to support mobility between 3GPP access 28 and non-3GPP accesses, such as coordination of information from PDN GW 24. 3GPP AAA server 32 interacts with HSS 36 using SWx interface 40 in order to maintain consistent information for user supporting mobility and service continuity between 3GPP access 28 and non-3GPP access. 3GPP AAA server 32 is configured to communicate with PDN GW 24 via an interface, such as S6b interface 34. Additionally, 3GPP AAA server 32 is in communication with TWAN 16 via an interface, such as STa interface 33.

HSS entity 36 may include a master database for a given user. HSS entity 36 may store subscription related information to support the network entities handling the transmission of packets to and from UE 20 associated with the user. HSS entity 36 provides support to call control servers in order to complete the routing and roaming procedures by solving authentication, authorization, naming resolutions, address resolutions, location dependencies, etc. A home network may contain one or several HSS entities 36, depending on the number of mobile subscribers. A large number of subscribers may be partitioned across multiple HSS entities 36 deployed in 3GPP network 12. HSS entity 36 communicates with 3GPP access 28 via an interface, such as S6a interface 38. HSS entity 36 also communicates with 3GPP AAA server 32 using an interface, such as SWx interface 40.

PCRF 42 may be an entity designated in real-time to determine policy rules in 3GPP network 12. PCRF 42 accesses subscriber databases and aggregates information to and from 3GPP network 12 in real time. PCRF 42 supports the creation of 3GPP rules, such as 3GPP PCC rules, and makes policy decisions for each subscriber active on 3GPP network 12. PCRF 42 may be integrated with different platforms that may include billing and rating. PCRF 42 may be deployed as a standalone entity. PCRF 42 acts as a policy decision point for policy and changing control of service data flows/application and IP bearer resources. PCRF 42 selects and provides the applicable policy and charging control decision, including providing dynamic QoS control policies for the purpose of allocating QoS resources. PCRF 42 is in communication with Serving Gateway 26 via an interface, such as Gxc interface 52; with PDN GW 24 via an interface, such as Gx interface 50, and Operator's IP Services server 44 via an interface, such as Rx interface 54.

Operator's IP Services server 44 may include a router that provides services, such as Internet, IPTV, etc. Of note, interfaces S6a 38, Gxc 52, SWx 40, Rx 54, SGi 48, S6b 34, S5 30, S2a 46, STa 33, SWw 22, etc. as used herein are defined in the 3GPP standards and described in the 3GPP standard specifications and technical documentation. These interfaces are known to a person having ordinary skill in the art and further description of the details of the interfaces is beyond the scope of the invention.

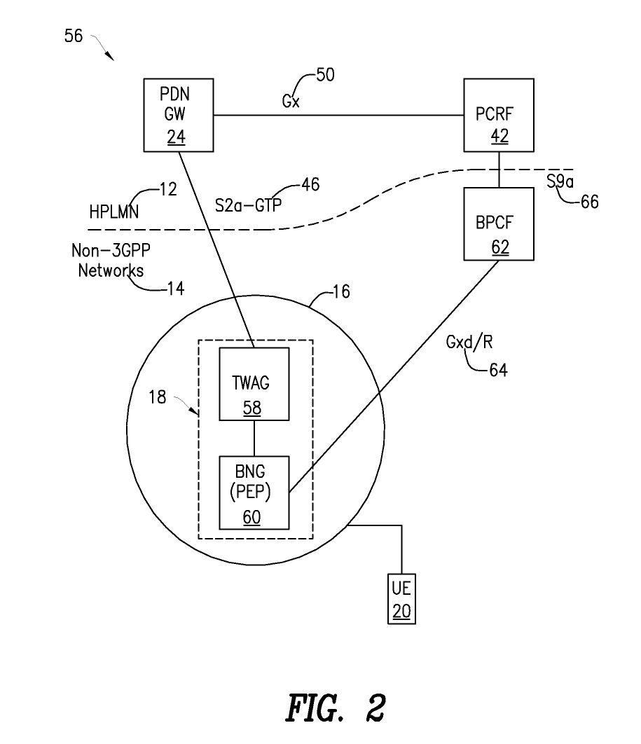

Another exemplary interworking architecture 56 for routing packets between 3GPP network 12 and non-3GPP network 14 is described with reference to FIG. 2. TWAN 16 includes TWAG computer 18. TWAG computer 18 includes Trusted Wireless Access Gateway (“TWAG”) 58 and Broadband Network Gateway Policy Enforcement Point (“BNG/PEP”) 60. In one exemplary embodiment, TWAG 58 may be implemented as a gateway computer or a router, a Policy Charge Enforcement Point may be implemented as a function in TWAG 58, and BNG/PEP 60 may be an implementation of TWAG 58. Architecture 56 also includes Broadband Policy Control Framework (“BPCF”) 62. TWAG 58 and BNG/PEP 60 may be in communication with BPCF 62 via an interface, such as Gxd/R interface 64. BPCF 62 communicates with PCRF 42 via an interface, such as S9a interface 66. TWAG computer 18 acts as a non-3GPP access of TWAN 16, and communicates with PDN GW 24 via an interface, such as S2a interface 46. TWAG 58 and BNG/PEP 60 allow 3GPP network 12 and TWAN 16 to interwork, specifically, TWAG 58 and BNG/PEP 60 allow 3GPP QoS requirements to be applied in non-3GPP network 14, e.g., TWAN 16.

The interworking of 3GPP network 12 and TWAN 16 allows the provision of services over both fixed and wireless networks, while maintaining QoS requirements. Interworking can be achieved for UE 20 devices that move between the different access types and service providers (served access locations include broadband home networks, public hot spots, WiFi, intranets and public zones). In an exemplary embodiment, TWAN computer 18 is configured for interworking 3GPP network 12 and non-3GPP network 14, e.g., TWAN 16. TWAN computer 18 takes into account different functions, such as the exchange of subscriber policies across access networks for QoS control. For example, the following service provider interworking models may be considered: (i) A fixed service provider (“SP”) and 3GPP SP collaborating to deliver services across both networks; and (ii) a service provider offering both fixed non-3GPP and 3GPP wireless access and services.

With regard to 3GPP's three-phase Broad Band Forum Accesses Interworking (“BBAI”) approach, the interworking between 3GPP and BBF architectures for authentication may include policy and QoS interworking. Policy and QoS interworking may be implemented by including TWAN computer 18 in the architecture of TWAN 16. Optionally, BPCF 62 may be included when non-3GPP network 14, e.g., TWAN 16, is large enough to warrant use of a separate policy management element. If non-3GPP network 14 is small, then the functions of BPCF 62 may be performed by TWAN computer 18, specifically BNG/PEP 60.

Non-3GPP access, such as TWAN computer 18 in TWAN 16 may interwork with 3GPP network 12 using, for example, S2a interface 46 or an S2b interface. TWAN computer 18 may use S2a interface 46 to communicate with PDN GW 24 if trusted access procedures are used to connect to the mobile core network, i.e., 3GPP network 12. An S2b interface may be used when untrusted access procedures are used to connect to the mobile core network. Whether trusted or untrusted access procedures are used to communicate over the non-3GPP network 14, e.g., a BBF network, may not depend on the non-3GPP network 14 itself, but it may be a decision made by both service providers in each network, specially the 3GPP mobile network provider. S2a interface 46 between trusted non-3GPP network 14, e.g., TWAN 16, and PDN GW 24, provides user plane tunneling and tunnel management between the trusted non-3GPP access, e.g., TWAN computer 18, and PDN GW 24.

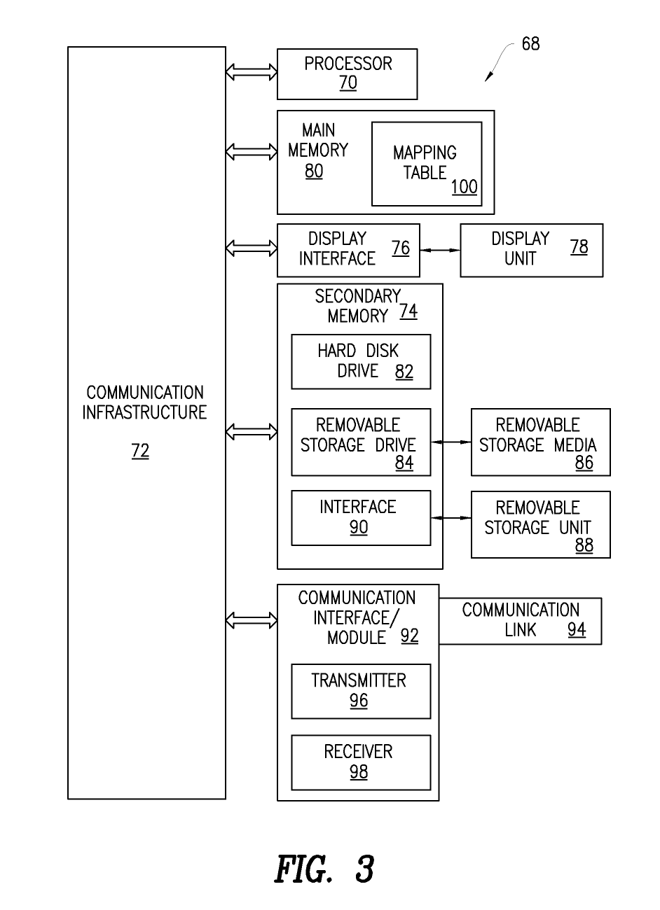

An exemplary computer 68 is described with reference to FIG. 3. TWAN computer 18, PDN GW 24, Serving Gateway 26, 3GPP access 28, 3GPP AAA server 32, HSS entity 36, PCRF 42, and Operator's IP Services server 44 may be implemented using one or more computers 68. Also, BPCF 62, TWAG 58 and BNG/PEP 60 may be implemented by one or more computers 68. In one embodiment, TWAN computer 18 includes at least one of TWAG 58, BNG/PEP 60 and BPCF 62. In another embodiment, each of BPCF 62, TWAG 58 and BNG/PEP 60 may be implemented separately, e.g., each of BPCF 62, TWAG 58 and BNG/PEP 60 may be implemented using a different computer 68.

In an exemplary embodiment, computer 68 includes one or more processors, such as processor 70 programmed to perform the functions described herein. Processor 70 is operatively coupled to a communication infrastructure 72, e.g., a communications bus, cross-bar interconnect, network, etc. Processor 70 may execute computer programs stored on disk storage for execution via secondary memory 74.

Computer 68 may optionally include or share a display interface 76 that forwards graphics, text, and other data from the communication infrastructure 72 (or from a frame buffer not shown) for display on the display unit 78. Display unit 78 may be a cathode ray tube (CRT) display, a liquid crystal display (LCD), light-emitting diode (LED) display or touch screen display, among other types of displays. The computer system also includes a main memory 80, such as random access memory (“RAM”) and read only memory (“ROM”), in addition to secondary memory 74. Main memory 80 may store Table 100, described below.

Secondary memory 74 may include, for example, a hard disk drive 82 and/or a removable storage drive 84, representing a removable hard disk drive, magnetic tape drive, an optical disk drive, etc. The removable storage drive 84 reads from and/or writes to a removable storage media 86 in a manner well known to those having ordinary skill in the art. Removable storage media 86, represents, for example, a floppy disk, external hard disk, magnetic tape, optical disk, etc. which is read by and written to by removable storage drive 84. As will be appreciated, the removable storage media 86 includes a computer usable storage medium having stored therein computer software and/or data.

In alternative embodiments, secondary memory 74 may include other similar devices for allowing computer programs or other instructions to be loaded into the computer system and for storing data. Such devices may include, for example, a removable storage unit 88 and an interface 90. Examples of such may include a program cartridge and cartridge interface (such as that found in video game devices), flash memory, a removable memory chip (such as an EPROM, EEPROM or PROM) and associated socket, and other removable storage units 88 and interfaces 90 which allow software and data to be transferred from the removable storage unit 88 to other devices.

Computer 68 also includes a communications interface 92. Communications interface 92 allows software and data to be transferred to external devices. Examples of communications interface 92 may include a modem, a network interface (such as an Ethernet card), a communications port, a PCMCIA slot and card, wireless transceiver/antenna, etc. Software and data transferred via communications interface/module 92 may be, for example, electronic, electromagnetic, optical, or other signals capable of being received by communications interface 92. These signals are provided to communications interface 92 via the communications link (i.e., channel) 94. Channel 94 carries signals and may be implemented using wire or cable, fiber optics, a phone line, a cellular phone link, an RF link, and/or other communications channels. Communication interface 82 may include transmitter 96 and receiver 98.

It is understood that computer 68 may have more than one set of communication interface 92 and communication link 94. For example, computer 68 may have a communication interface 92/communication link 94 pair to establish a communication zone for wireless communication, a second communication interface 92/communication link 94 pair for low speed, e.g., WLAN, wireless communication, another communication interface 92/communication link 94 pair for communication with optical networks, and still another communication interface 92/communication link pair for other communication.

Computer programs (also called computer control logic) are stored in main memory 80 and/or secondary memory 74. For example, computer programs are stored on disk storage, i.e. secondary memory 74, for execution by processor 70 via RAM, i.e. main memory 80. Computer programs may also be received via communications interface 92. Such computer programs, when executed, enable the method and system to perform the features of the present invention as discussed herein. In particular, the computer programs, when executed, enable processor 70 to perform the features of the corresponding method and system. Accordingly, such computer programs represent controllers of the corresponding device.

Computer 68 functionality may be performed by a single server or distributed among multiple servers or computing devices. For example, computer 68 functionality may be performed by an internal or off-site server. Alternatively, computer 68 functionality may be performed by several computing devices that may be located in the same general location or different locations, e.g., cloud computing. In other words, each computing device may perform one or more particular sub-processes of computer 68, and may communicate with each other via a communication network. As such, computer 68 may be a system of components, some of which may be virtual components, or software components that function collectively to perform the features of the invention. As such, TWAN computer 18, PDN GW 24, Serving Gateway 26, 3GPP access 28, 3GPP AAA server 32, HSS entity 36, PCRF 42, Operator's IP Services server 44, BPCF 62, TWAG 58 and BNG/PEP 60 may be implemented using hardware or as a combination of software and hardware.

Various software embodiments are described in terms of this exemplary computer system. It is understood that computer systems and/or computer architectures other than those specifically described herein can be used to implement the invention. It is also understood that the capacities and quantities of the components of the architecture described above may vary depending on the device, the quantity of devices to be supported, as well as the intended interaction with the device. For example, configuration and management of computer 68 may be designed to occur remotely by web browser. In such case, the inclusion of a display interface and display unit may not be required.

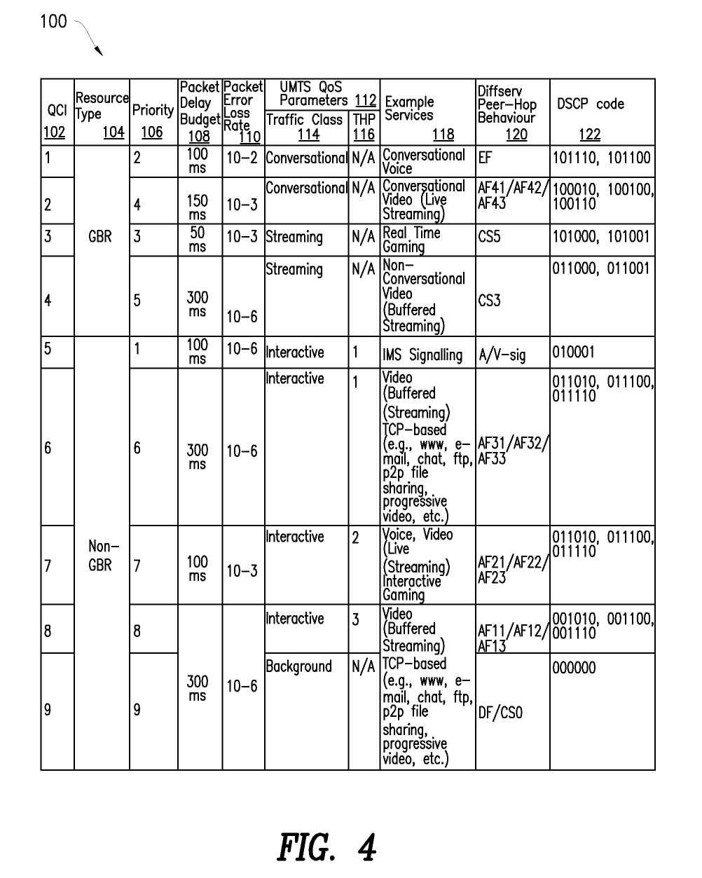

An exemplary mapping Table 100 is described with reference to FIG. 4. Exemplary Table 100 illustrates a mapping of 3GPP QoS rules to non-3GPP rules. Specifically, Table 100 maps 3GPP parameters corresponding to a 3GPP PCC rule to BBF parameters, such as Diffserv Code Point (“DSCP”) values 122, corresponding to a local BBF rule, i.e., a non-3GPP rule. TWAN computer 18, TWAG 58, BNG/PEP 60 and/or BPCF 62 may store Table 100. Table 100 allows the maintenance of QoS of service sessions when UE 20 moves between 3GPP network 12 and non-3GPP network 14. An QoS agreement between a provider in 3GPP network 12 and provider in non-3GPP network 14 determines the QoS supported when services such as voice, video, text messaging, and data services are provided by 3GPP network 12 and non-3GPP network 14.

A Policy and Charging Control (“PCC”) architecture in 3GPP network 12 provides tools for service-aware policy and charging control. Policy control includes support for controlling the QoS (e.g., QoS class and bit rate) authorized for services. Charging control enables IP flow based charging, including for example, online credit control. The PCC architecture includes PCRF 42, which acts as the policy decision point, and a Policy and Charging Enforcement Function (“PCEF”) (not shown).

A signaling message, sent by PDN GW 24 to TWAG 58, includes the 3GPP PCC rule and the 3GPP parameters associated with the 3GPP PCC rule. The 3GPP parameters may include but are not limited to, QoS Class Identifier (“QCI”) 102, Allocation and Retention Policy (“ARP”), Guaranteed Bit Rate (“GBR”) 104, and Maximum Bit Rate (“MBR”). Other 3GPP parameters may include, for example, a maximum bit error rate, etc.

Since the 3GPP parameters associated with 3GPP PCC rules are different from the non-3GPP parameters associated with BBF rules, e.g., non-3GPP rules, a mapping mechanism is proposed. 3GPP parameters associated with a 3GPP PCC rule are matched to non-3GPP parameters supported at, for example, a BBF node in non-3GPP network 14. The desired QoS in non-3GPP network 14 can be determined, for example, by appropriate selection of a QoS indicator such as DSCP, Experimental Bit (“EXP Bit”), or Poll Bit (“P-Bit”), among other indicators. The choice of indicator and its value is determined by the service providers based on Service Level Agreements (“SLA”).

Exemplary Table 100 may include a mapping of 3GPP rules and 3GPP parameters to non-3GPP rules and non-3GPP parameters. Exemplary Table 100 includes the following exemplary 3GPP parameters: QCI value 102, resource type value 104, priority value 106, packet delay budget value 108, packet error loss rate value 110 and diffserv peer-hop behavior value 120 mapped to non-3GPP parameter DSCP code 122. Example services value 118 is provided for an operator to easily identify the services that fall under the corresponding QCI value 102. Table 100 additionally includes legacy Universal Mobile Telecommunications System (“UMTS”) QoS parameters 112 which include traffic class value 114 and traffic handling priority (“THP”) value 116, both mapped to DSCP code 122. If an access is a UMTS access, then TWAG 58 determines which DSCP code 122 correspond to the UMTS QoS parameters 112, and routes the packet using the corresponding DSCP code 122.

Of note, although data is described herein as being stored in a “table,” the invention is not limited to such. Any format for storing data may be used to implement the invention, e.g. flat file, a hash table, a matrix, a data structure, etc. It is contemplated that any memory storage device can store data in an organized and retrievable form. Further, Table 100 may include more or less parameters, i.e., Table 100 may include any number of parameters and any other type of data.

The first line of Table 100 includes the following 3GPP PCC rule and 3GPP parameters: a QCI value 102 of “1;” a resource type value 104 of “GBR;” a packet delay budget value 108 of “100 ms;” a packet error loss rate value 110 of “10⁻²” (which indicates that 10⁻² packets may be lost); a traffic class value 114 that indicates the packet is a “conversational” packet (other possible values include “streaming,” “interactive,” “background,” etc.); a THP value 116 that is “N/A (other possible values include 1, 2, 3, etc.);” an example services value 118 of “conversational voice;” and/or a Diffserv peer-hoop behavior value 120 of “Expedited Forwarding” (“EF”) (other possible values include Assured Forwarding, etc.). These 3GPP parameters are mapped to a DSCP code 122

In an exemplary embodiment, TWAN computer 18 may be configured to receive a signaling message that includes at least one of QCI value 102, resource type value 104, priority value 106, packet delay budget value 108, packet error loss rate value 110, diffserv peer-hop behavior value 120, example services value 118, traffic class value 114 and THP value 116, and may be configured to map at least one of QCI value 102, resource type value 104, priority value 106, packet delay budget value 108, packet error loss rate value 110, diffserv peer-hop behavior value 120, example services value 118, traffic class value 114 and THP value 116 to a DSCP code 122 in Table 100.

For example, when a 3GPP PCC rule and 3GPP parameters associated with a packet indicate a QCI value 102 of “1;” and/or a resource type value 104 of “GBR;” and/or a packet delay budget value 108 of “100 ms;” and/or a packet error loss rate value 110 of “10⁻²” (which indicates that 10⁻² packets may be lost); and/or a traffic class value 114 that indicates the packet is a “conversational” packet; and/or a THP value 116 that is “N/A;” and/or an example services value 118 of “conversational voice;” and/or a Diffserv peer-hoop behavior value 120 of “Expedited Forwarding” (“EF”), then the DSCP codes 122 used to route the packet in the non-3GPPP network are “101110” or “101100,” as the “DSCP codes 122 101110” and “101100” are mapped to the above 3GPP parameters.

A service provider may configure TWAG 58 to match one or more parameters of Table 100 in order to determine one or more DSCP codes. For instance, a service provider may choose to match just two 3GPP parameters and not all of the 3GPP parameters in Table 100 to determine the corresponding DSCP code 122. As an illustration, PDN GW 24 may send to TWAG 58 a signaling message associated with UE 20. The signaling message includes a 3GPP PCC rule and 3GPP parameters that include a QCI value 102 of “1” and a Packet Delay Budget value 108 of “100 ms.” TWAG 58 may be configured to translate a QCI value 102 of “1” and a Packet Delay Budget value 108 of “100 ms” to either DSCP code “101110” or “101100.” TWAG 58 inserts either DSCP code 122 “101110” or DSCP code 122 “101100” in the IP header of the packet. In this example, TWAG 58 chooses to mark/tag the DSCP field of the IP header of the packet with DSCP code 122 “101110.” As such, TWAG 58 applies DSCP code 122 “101110” when routing the packet in non-3GPP network 14. Future packets routed to and from UE 20 will be routed by applying the determined DSCP code 122 “101110.”

Thus, QoS interworking is made possible with the mapping of 3GPP rules and 3GPP parameters (QCI value 102, resource type value 104, priority value 106, packet delay budget value 108, packet error loss rate value 110, and diffserv peer-hop behavior value 120) to non-3GPP rules and non-3GPP parameters (DSCP codes/values 122). A relationship between 3GPP PCC rules and non-3GPP rules enables wireless sessions to be transported between 3GPP network 12 and non-3GPP network 14 while keeping the same or equivalent QoS. The DSCP codes/values 122 specify the desired QoS in non-3GPP network 14. The interfaces between the 3GPP network 12 and the non-3GPP network 14 translate the 3GPP parameters by mapping them to DSCP codes/values 122 using Table 100.

In another exemplary embodiment, in addition to QoS information, accounting information may also be exchanged between 3GPP network 12 and non-3GPP network 14. The service providers in each network can have accounting and charge agreements with each other that depend on the QoS and class of service of traffic provided. For example, the accounting may take into consideration the QoS provided for traffic having a DSCP marking in IP packets sent and/or received from 3GPP UE 20 or based on a destination IP address. Accounting in fixed networks is typically performed at BNG/PEP 60 based on time and/or volume of traffic. BNG/PEP 60 can perform accounting functions and can send the data to the non-3GPP AAA server, e.g., TWAN computer 18, in non-3GPP network 14.

A 3GPP PCC rule may include an event trigger and a charging rule. A signaling message may include an event trigger that specifies an action for TWAN computer 18 when a condition is satisfied. For example, if the number of packets received by UE 20 exceed two Gigabytes, then TWAN computer 18, specifically BNG/PEP 60, may send a message to the charging system that UE 20 has gone over its data limit. A charging rule may include an action to be performed based on an event. For example, if 3GPP UE 20 accesses non-3GPP network 14, then non-3GPP network 14 may determine not to charge UE 20 for accessing non-3GPP network 14 in order to encourage UE 20 to use a WiFi connection and not a radio connection, as using the WiFi connection preserves radio bandwidth.

Table 100 may be generated at any time, for example, Table 100 may be created when BNG/PEP 60 is installed, by parameter setting, etc. In one embodiment, Table 100 may be generated and stored in TWAG 58, BNG/PEP 60, BPCF 62 and/or TWAN computer 18 by an operator of the non-3GPP network 14 when at least one of TWAG 58, BNG/PEP 60, BPCF 62 or TWAN computer 18 is installed. In another embodiment, TWAG 58, BNG/PEP 60, BPCF 62 and/or TWAN computer 18 may store a master Table 100. TWAG 58, BNG/PEP 60, BPCF 62 and/or TWAN computer 18 may be configured to generate a smaller mapping Table 100 for each UE 20 or for each user service. Table 100 may be updated and modified at any time. Table 100 may be modified dynamically or may be hard coded.

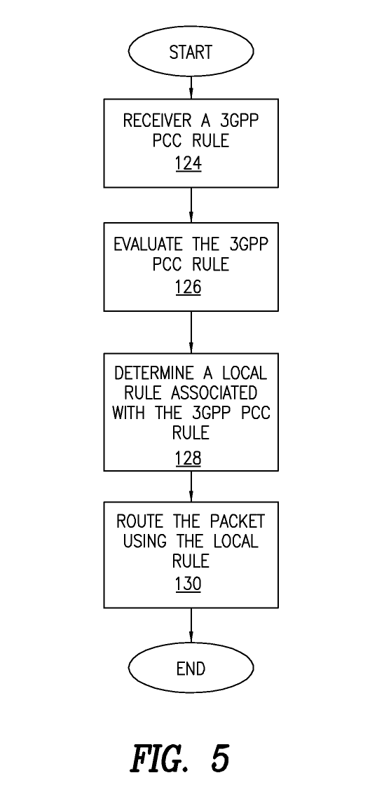

FIG. 5 is a flowchart of an exemplary method for routing a packet between UE 20 and non-3GPP network 14. Receiver 98 in TWAN computer 18 receives a 3GPP PCC rule from PDN GW 24 via a first type interface, which may be S2a interface 46 (Block 124). The S2a interface terminates at TWAN computer 18, specifically TWAG 58. The GTP-C protocol carries over S2a the QoS requirements associated with the IP flows carried by the S2a bearers. Processor 70 in TWAN 18 (the BBF access in non-3GPP network 14) may evaluate the 3GPP PCC rule and determine the relevant non-3GPP rule and non-3GPP parameters, e.g., BBF QoS parameters (Block 126). TWAN computer 18 may determine, using Table 100, a local rule, e.g., a non-3GPP rule, associated with the 3GPP PCC rule (Block 128). TWAN computer 18 routes the packet on non-3GPP network 14 to UE 20 using the determined local rule (Block 130).

In another exemplary embodiment, non-3GPP network 14 is a BBF network, the 3GPP PCC rule is a 3GPP PCC QoS rule, and the local rule is a BBF local rule. TWAN computer 18 or BPCF 62 generate Table 100, which is a mapping table mapping the received 3GPP PCC QoS rule to the BBF local rule. TWAN computer 18 or BPCF 62 store mapping Table 100. Routing the packet on non-3GPP network 14 to and from UE 20 further includes applying, by processor 70 in TWAN computer 18, the BBF local rule associated with the 3GPP PCC QoS rule. Upon receiving a 3GPP PCC QoS rule from PDN GW 24, TWAN computer 18 determines the BBF local rule mapped to the 3GPP PCC QoS rule in mapping Table 100. Applying the BBF local rule associated with the 3GPP PCC QoS rule by TWAN computer 18 includes applying the determined BBF local rule when routing the packet to/from UE 20. The receiving of the 3GPP PCC QoS rule and applying of the BBF local rule may performed by TWAN computer 18, which may be and/or include at least one of BPCF 62, TWAG 58 and BNG/PEP 60.

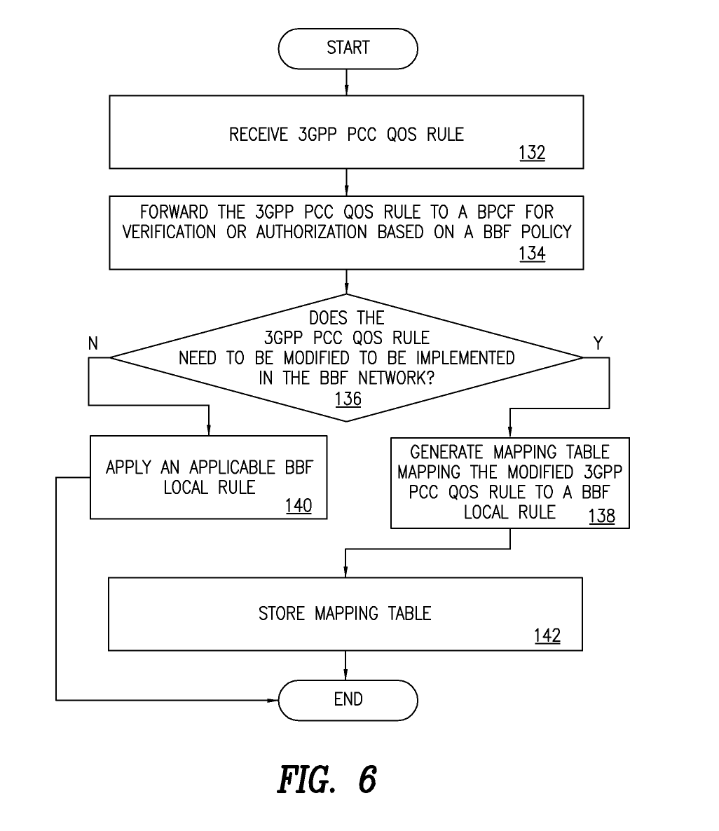

FIG. 6 is a flowchart of an exemplary method for generating and storing mapping Table 100 in an interworking architecture that includes both TWAG 58 and BPCF 62. TWAG 58 receives a 3GPP PCC QoS rule (Step 132). TWAG 58 forwards the 3GPP PCC QoS rule to BPCF 62 for verification and/or authorization based on a BBF policy (Block 134). BPCF 62 analyzes the 3GPP PCC QoS rule based on a policy and responds to TWAG 58. TWAG 58 determines, based on the response from BPCF 62, whether the 3GPP PCC QoS rule needs to be modified in order to be implemented in non-3GPP network 14 (Block 136). If the 3GPP PCC QoS rule needs to be modified, TWAG 58 generates Table 100 to map the 3GPP PCC QoS rule to a BBF local rule (Block 138) (if Table 100 already exists, TWAG 58 modifies Table 100 to include the 3GPP PCC QoS rule). Mapping Table 100 is stored in TWAG 58 (Block 142). Else, if the 3GPP PCC QoS rule does not need to be modified, e.g., the 3GPP PCC QoS rule is not supported by non-3GPP network 14, TWAN computer 18 is configured to apply a BBF local rule (Block 140).

In another embodiment, routing the packet in the non-3GPP network includes BPCF 62 sending information to TWAG 58, as BPCF 62 stores Table 100. TWAG computer 18 sends a query to BPCF 62 including the 3GPP PCC rule. In this embodiment, BPCF 62, and not TWAN computer 18, may determine whether the 3GPP PCC QoS rule needs to be modified to a non-3GPP rule in order to be implemented in non-3GPP network 14. If so, BPCF 62 determines the non-3GPP rule mapped to the 3GPP PCC QoS rule in Table 100, and sends the query response including the non-3GPP rule to TWAN computer 18. If mapping Table 100 does not include a BBF local rule associated with the 3GPP PCC QoS rule, BPCF 62 creates a new entry in mapping Table 100 to include the modified 3GPP PCC QoS rule in association with a BBF local rule.

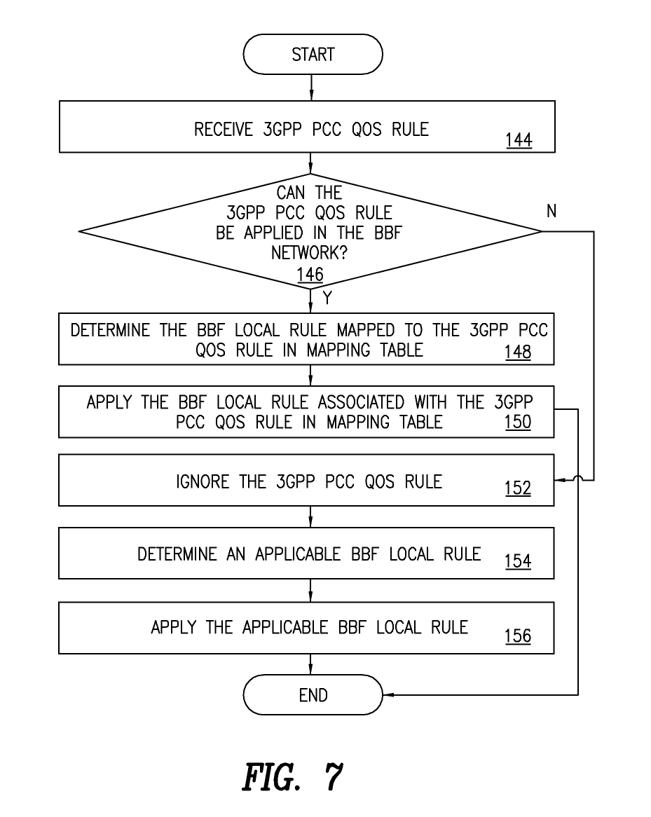

FIG. 7 is a flowchart of an exemplary method for routing a packet in non-3GPP network 14, using an interworking architecture where TWAN computer 18 performs the functions of TWAG 58, BNC/PEP 60 and BPCF 62, e.g., the architecture does not include a separate BPCF 62. TWAN computer 18 receives a 3GPP PCC QoS rule from PDN GW 24 or BPCF 62 (Block 144). TWAN computer 18 determines whether the 3GPP PCC QoS rule can be applied in the non-3GPP network 14, e.g., the BBF network (Block 146). The 3GPP PCC QoS rule may include at least one of a QoS QCI value, an ARP value, a GBR value, an MBR value, an event trigger and a charging rule.

If TWAN computer 18 determines that the 3GPP PCC QoS rule can be applied in the BBF network, then TWAN computer 18 modifies the 3GPP PCC QoS rule, i.e., determines the BBF local rule mapped to the 3GPP PCC QoS rule in mapping Table 100 (Block 148). TWAN computer 18 applies the BBF local rule associated with the 3GPP PCC QoS rule in mapping Table 100 (Block 150). Else, if TWAN computer 18 determines that the 3GPP PCC QoS rule cannot be applied in the BBF network, then TWAN computer 18 ignores the 3GPP PCC QoS rule (Block 152). TWAN computer 18 may determine an applicable non-3GPP rule, e.g., a BBF local rule (Block 154), and may apply the applicable BBF local rule to route packets to and from UE 20 (Block 156).

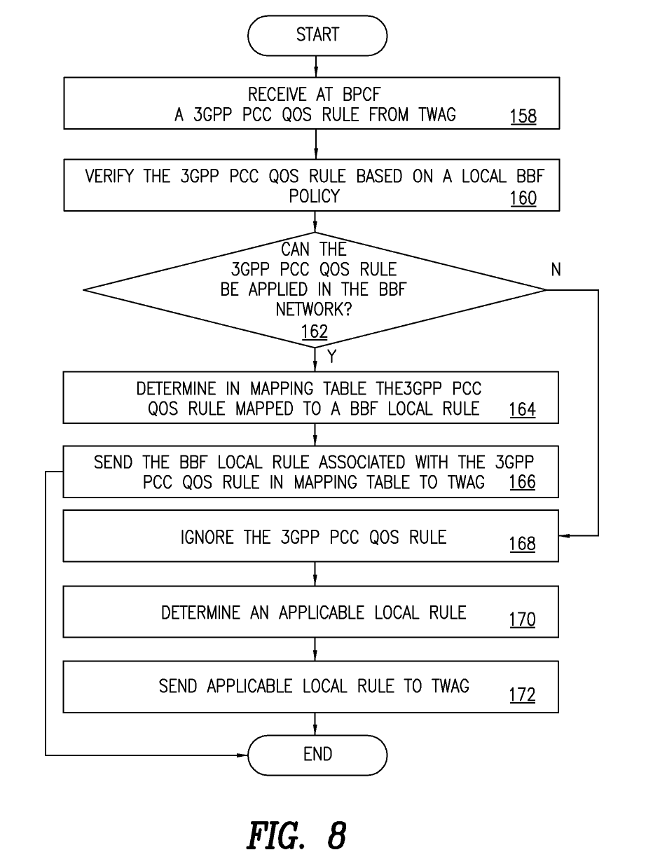

FIG. 8 is a flowchart of an exemplary method performed by BPCF 62 for determining a non-3GPP rule to be applied when routing a packet in non-3GPP network 14. BPCF 62 receives a 3GPP PCC QoS rule from TWAG 58 or PCRF 42 (Block 158). BPCF 62 verifies the 3GPP PCC QoS rule based on a local BBF policy (Block 160) and determines whether the 3GPP PCC QoS rule can be applied in non-3GPP network 14, e.g. the BBF network (Block 162). If the 3GPP PCC QoS rule can be applied in non-3GPP network 14, e.g., a BBF network, then BPCF 62 determines in mapping Table 100 the non-3GPP rule including non-3GPP parameters, e.g., a BBF local rule and BBF parameters, mapped to the 3GPP PCC QoS rule and the 3GPP parameters (Block 164). BPCF 62 sends the non-3GPP rule including the non-3GPP parameters, e.g., the BBF local rule including the local BBF parameters, associated with the 3GPP rule to TWAG 58 (Block 166). BPCF 62 may also send to TWAN computer 18 an event trigger and a charging rule. Else, if the 3GPP PCC QoS rule cannot be applied in the non-3GPP network 14, e.g., the BBF network, BPCF 62 ignores the 3GPP PCC QoS rule (Block 168). BPCF 62 may determine an applicable local rule (Block 170) and may send the applicable local rule to TWAG 58 (Block 172), so that TWAG 58 may apply the applicable local rule when routing packets to and from UE 20. Of note, any of the steps of FIGS. 5-8 may be optional. It is not required that all of the steps be performed. Additionally, the steps may be performed in a different order than the order shown.

In another exemplary embodiment, TWAN computer 18 receives via S2a interface 46 the 3GPP PCC QoS rule from a 3GPP computer, such as PDN GW 24. QoS information is transferred from PDN GW 24 to TWAG 58. The S2a bearer uniquely identifies traffic flows that receive a common QoS treatment. PDN GW 24 refers to a QoS policy to assign the S2a bearer QoS, i.e., PDN GW 24 assigns the values to the QoS parameters, e.g., QCI, ARP, GBR and MBR, among other parameters. PDN GW 24 sends a Create Bearer Request message to TWAG 58 in the non-3GPP domain, e.g., the BBF domain. TWAG 58 receives and evaluates the 3GPP PCC QoS rule. TWAG 58 transmits the 3GPP PCC QoS rule to BNG/PEP 60. BNG/PEP 60 may store Table 100 and may look up in Table 100 which local rule maps to the received 3GPP PCC QoS rule (this configuration may be used in small non-3GPP networks 14). Alternatively, in large non-3GPP networks 14, BNG/PEP may send the 3GPP PCC QoS rule to BPCF 62 for one of verification and authorization of the 3GPP PCC QoS rule based on a BBF policy. BPCF 62 may perform a look-up in mapping table 100 to determine which local rule is mapped to the received 3GPP PCC QoS rule. Once the local rule is determined by BPCF 62, BPCF 62 sends the local rule to BNG/PEP 60.

In another exemplary embodiment, BPCF 62 may receive the 3GPP PCC QoS rule from PCRF 42 via an S9a interface. BPCF 62 looks-up in mapping Table 100 the local rule to which the received 3GPP QoS rule maps to. BPCF 62 sends a local rule to TWAG 58 and/or BNG/PEP 60 in TWAN computer 18.

In another exemplary embodiment, PCRF 42 sends the local IP Address of an IPSec tunnel over the S2a interface to TWAN computer 18. The information received over the S2a interface by TWAN computer 18 enables the non-3GPP network 14, e.g., BBF network, to determine the entities in the BBF access that 3GPP UE 20 connects to. The DSCP value is derived from the QCI to DSCP mapping. The DSCP value and the information received identify a service data flow through the IPSec tunnel at BNG/PEP 60. The user plane packets for 3GPP UE 20 in the non-3GPP domain, e.g., BBF domain, are identified using the IP address and UDP port received by the BPCF 62 over an S2a interface or S9a interface 66.

In another exemplary embodiment, UE 20 registers its location with a first carrier. The GTP-C protocol carries over S2a the QoS requirements associated with the IP flows carried by the S2a bearers. Non-3GPP network 14 may determine the relevant BBF QoS policies to apply to the IP flows exchanged on this Packet Data Network connection. The BBF access, e.g., TWAN computer 18, may perform resource and admission control. Non-3GPP network 14 performs the appropriate mapping between the EPS Bearer QoS parameters received via GTP based S2a interface from 3GPP network 12 and the QoS parameters used in Fixed Broadband access non-3GPP network 14.

In another exemplary embodiment, the BBF solution based on GTP based S2a addresses the scenario where the 3GPP EPC and the BBF network are operated by different administrative entities. This architecture may also support the scenario of a single network operator deploying both the 3GPP EPC and the BBF network.

In another exemplary embodiment, non-3GPP network 14, e.g., the BBF network, may not sustain the QoS requested over S2a, i.e., the 3GPP rule may not be supported in non-3GPP network 14. BPCF 62 or TWAN computer 18 may send a counter-offer to PCRF 42 or PDN GW 24 when requested resources for a service data flow with the requested QoS parameters, such as Uplink/Downlink Bandwidth (“UL/DL BW”) and QoS class, cannot be granted by BPCF 62 or TWAN computer 18. BPCF 62 or TWAN computer 18 may receive from PCRF 42 or PDN GW 24 a different 3GPP rule. BPCF 62 or TWAG 58 may transmit the different 3GPP rule to BNG/PEP 60. Alternatively, BPCF 62 may ignore the 3GPP rule and may send to TWAN computer 18, specifically BNG/PEP 60, a default or alternative local rule to apply when sending and receiving packets from UE 20.

The following are exemplary scenarios where the 3GPP QoS parameters have been considered when routing traffic in non-3GPP network 14. In an exemplary embodiment, a provider specific service may include Internet access with parental control and a personal firewall. This specific service may be invoked for specific devices associated with children, regardless of the network access type, as children leave their fixed access non-3GPP network 14 at home and can connect to 3GPP access 28 on a bus or a non-3GPP network 14 WiFi hot spot at a restaurant. The non-3GPP network 14 at home, 3GPP network 12 and the non-3GPP network 14 WiFi hotspot are more than likely operated by different network providers. TWAN computer 18 ensures that the parental control and personal firewall will be provided by the service providers of both 3GPP network 12 and non-3GPP network 14.

In another exemplary embodiment, a person travels to work while talking on their UE 20. The ongoing voice/multimedia call is maintained while switching over 3GPP access 28 and non-3GPP network 14 WiFi access, which may be installed at the work location. The bandwidth QoS is maintained for the duration of the call to guarantee the same service delivery. In yet another exemplary embodiment, a child in the backseat of a car may watch an Internet TV show on UE 20, which may be a laptop, using 3GPP network 12 to connect to the Internet TV provider while the car travels to a destination, e.g., home. Once at the destination, UE 20 detects indoor WiFi coverage through a WiFi residential gateway connected to a fixed broadband network, such as non-3GPP network 14. UE 20 may automatically select to switch the IP connection to the fixed WiFi broadband connection. UE 20 may receive better quality picture if allowed by the available bandwidth user-specific policy, network policy and QoS setting.

The present invention can be realized in hardware, or a combination of hardware and software. Any kind of computing system, or other apparatus adapted for carrying out the methods described herein, is suited to perform the functions described herein. A typical combination of hardware and software could be a specialized computer system, e.g., a point of sale terminal, having one or more processing elements and a computer program stored on a storage medium that, when loaded and executed, controls the computer system such that it carries out the methods described herein. The present invention can also be embedded in a computer program product, which comprises all the features enabling the implementation of the methods described herein, and which, when loaded in a computing system is able to carry out these methods. Storage medium refers to any volatile or non-volatile storage device.

Computer program or application in the present context means any expression, in any language or notation, of a set of instructions intended to cause a system having an information processing capability to perform a particular function either directly or after either or both of the following a) conversion to another language, code or notation; b) reproduction in a different material form.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A method for routing a packet in a non 3rd Generation Partnership Project, 3GPP, network, the method comprising:
receiving, via a first type interface, a 3GPP Policy and Charging Control, PCC, rule;
evaluating the 3GPP PCC rule;
determining a local rule associated with the 3GPP PCC rule; and
routing the packet on the non-3GPP network to a user equipment using the determined local rule.

2. The method of claim 1, wherein the non-3GPP network is a Broadband Forum, BBF, network, the first type interface is an S2a interface and the local rule is a BBF local rule, and wherein routing the packet further comprises:
applying the BBF local rule associated with the 3GPP PCC rule.

3. The method of claim 2, further comprising:
generating a mapping table mapping the received 3GPP PCC rule to the BBF local rule; and
storing the mapping table.

4. The method of claim 3, further comprises:
determining the BBF local rule mapped to the 3GPP PCC rule in the mapping table; and
wherein applying the BBF local rule associated with the 3GPP PCC rule includes applying the determined BBF local rule.

5. The method of claim 2, wherein the 3GPP PCC rule is a 3GPP PCC Quality of Service, QoS, rule, and wherein the mapping table is stored in at least one of a Broadband Policy Control Framework, BPCF, computer, a Trusted Wireless Access Gateway, TWAG, computer, and a Border Network Gateway Policy Enforcement Point, BNG/PEP computer.

6. The method of claim 2, wherein the receiving and applying is performed by a Trusted Wireless Local Area Network Access Network, TWAN, computer, the TWAN computer being one of a Broadband Policy Control Framework, BPCF, computer, a Trusted Wireless Access Gateway, TWAG, computer and a Border Network Gateway Policy Enforcement Point, BNG/PEP computer.

7. The method of claim 2, further comprising:
determining whether the 3GPP PCC rule can be applied in the BBF network; and
if it is determined that the 3GPP PCC rule can be applied in the BBF network, then:
determining whether the 3GPP PCC rule needs to be modified to be implemented in the BBF network; and
if it is determined that the 3GPP PCC rule needs to be modified, then:
determining the BBF local rule associated with the 3GPP PCC rule;
wherein applying the BBF local rule further comprises applying the BBF local rule associated with the 3GPP PCC rule;
else, if it is determined that the 3GPP PCC rule cannot be applied in a BBF network, then:
ignoring the 3GPP PCC rule.

8. The method of claim 2, wherein the 3GPP PCC rule includes one of a Quality of Service, QoS, Class Identifier, QCI, value, an Allocation and Retention Policy, ARP, value, a Guaranteed Bit Rate, GBR value, a Maximum Bit Rate, MBR, value, an event trigger and a charging rule.

9. The method of claim 2, further comprising:
forwarding the received 3GPP PCC rule to a Broadband Policy Control Framework, BPCF, computer for one of verification and authorization of the 3GPP PCC rule based on a BBF policy.

10. The method of claim 2, wherein receiving, via the S2a interface, further includes receiving the 3GPP PCC rule from a 3GPP computer, and wherein the method further comprises:
receiving from a Policy and Charging Rules Function, PCRF, computer via an S9a interface, the 3GPP PCC rule.

11. A Trusted Wireless Local Area Network Access Network, TWAN, computer in a non 3rd Generation Partnership Project, 3GPP, network, the TWAN computer comprising:
a receiver configured to receive, via a first type interface, a 3GPP Policy and Charging Control, PCC, rule; and
a processor in communication with the receiver, the processor configured to:
evaluate the 3GPP PCC rule;
determine a local rule associated with the 3GPP PCC rule; and
route the packet on the non-3GPP network to a user equipment using the determined local rule.

12. The TWAN computer of claim 11, wherein the non-3GPP network is a Broadband Forum, BBF network, the first type interface is an S2a interface, the local rule is a BBF local rule, and wherein the processor is further configured to:
apply the BBF local rule associated with the 3GPP PCC rule to route the packet to the user equipment.

13. The TWAN computer of claim 12, wherein the processor is further configured to:
route a plurality of packets on the non-3GPP network from the user equipment using the BBF local rule; and
generate a mapping table mapping the received 3GPP PCC rule to the BBF local rule; and wherein the TWAN computer further comprises:
a memory in communication with the receiver and the processor, the memory being configured to store the mapping table.

14. The TWAN computer of claim 13, wherein the processor is further configured to determine the BBF local rule mapped to the 3GPP PCC rule in the mapping table; and
wherein the processor applying the BBF local rule associated with the 3GPP PCC rule includes the processor applying the determined BBF local rule to route the packet to the user equipment.

15. The TWAN computer of claim 12, wherein the 3GPP PCC rule is a 3GPP PCC Quality of Service, QoS, rule, and wherein the TWAN computer is one of a Broadband Policy Control Framework, BPCF, computer, a Trusted Wireless Access Gateway, TWAG, computer and a Border Network Gateway Policy Enforcement Point, BNG/PEP computer.

16. The TWAN computer of claim 12, wherein the processor is further configured to:
determine whether the 3GPP PCC rule can be applied in the BBF network; and
if the processor determines that the 3GPP PCC rule can be applied in the BBF network, then the processor is further configured to:
determine whether the 3GPP PCC rule needs to be modified in order to be implemented in the BBF network; and
if the processor determines that the 3GPP PCC rule needs to be modified, then the processor is further configured to:
determine the BBF local rule associated with the 3GPP PCC rule;
wherein the processor applying the BBF local rule further comprises the processor applying the BBF local rule associated with the 3GPP PCC rule;
else, if the processor determines that the 3GPP PCC rule cannot be applied in the BBF network, then the processor is further configured to:
ignore the 3GPP PCC rule; and
determine whether an applicable local BBF rule may be applied;
if the processor determines that an applicable local BBF rule may be applied, then the processor is further configured to apply the applicable local BBF rule.

17. The TWAN computer of claim 12, further comprising:
a transmitter in communication with the receiver and the processor, the transmitter being configured to forward the received 3GPP PCC rule to a Broadband Policy Control Framework, BPCF, computer for one of verification and authorization of the 3GPP PCC rule based on a BBF policy.

18. The TWAN computer of claim 12, wherein the receiver is further configured to:
receive the 3GPP PCC rule from a 3GPP computer; and
receive from a Broadband Policy Control Framework, BPCF, computer the 3GPP PCC rule.

19. A Broadband Forum, BBF, system comprising:
a Trusted Wireless Local Area Network Access Network, TWAN, computer, the TWAN computer including:
a TWAN receiver configured to receive via a first type interface from a 3rd Generation Partnership Project, 3GPP, Packet Data Network Gateway, PDN GW, computer, a 3GPP Policy and Charging Control, PCC, Quality of Service, QoS rule; and
a TWAN processor in communication with the TWAN receiver, the TWAN processor configured to:
evaluate the 3GPP PCC QoS rule;
determine a BBF local rule associated with the 3GPP PCC QoS rule; and
route the packet on the non-3GPP network to a user equipment using the determined BBF local rule.

20. The BBF system of claim 19, wherein the first type interface is an S2a interface, and wherein the TWAN processor is further configured to:
apply the BBF local rule associated with the 3GPP PCC QoS rule to route the packet to the user equipment; and
generate a mapping table mapping the received 3GPP PCC QoS rule to the BBF local rule; and wherein the TWAN computer further comprises:
a TWAN memory in communication with the TWAN receiver and the TWAN processor, the TWAN memory being configured to store the mapping table.

21. The BBF system of claim 20, wherein the TWAN processor is further configured to determine the BBF local rule mapped to the 3GPP PCC QoS rule in the mapping table; and
wherein the processor applying the BBF local rule associated with the 3GPP PCC QoS rule includes the processor applying the determined BBF local rule when routing the packet to the user equipment.

22. The BBF system of claim 20, further comprising:
a Broadband Policy Control Framework, BPCF, computer, the BPCF computer being configured to communicate with the TWAN computer, the BPCF computer including:
a BPCF receiver, the BPCF receiver configured to receive from a Policy and Charging Rules Function, PCRF, computer via a second type interface, the 3GPP PCC QoS rule;
a BPCF processor in communication with the BPCF receiver, the BPCF processor configured to generate a mapping table mapping the received 3GPP PCC QoS rule to the BBF local rule; and
a BPCF memory in communication with the BPCF receiver and the BPCF processor, the BPCF memory being configured to store the mapping table.

23. The BBF network system of claim 20, wherein the TWAN computer further includes:
a TWAN transmitter in communication with the TWAN receiver and the TWAN processor, the TWAN transmitter configured to send a query to a Broadband Policy Control Framework, BPCF, computer;
the TWAN receiver being further configured to receive a query response from the BPCF computer; and
the TWAN processor being further configured to determine, based at least in part on the query response, whether the 3GPP PCC QoS rule needs to be modified in order to be implemented in a BBF network; and
if the TWAN processor determines that the 3GPP PCC QoS rule needs to be modified, then the TWAN processor is further configured to:
determine the BBF local rule associated with the 3GPP PCC QoS rule;
else, if the TWAN processor determines that the 3GPP PCC QoS rule cannot be applied in the BBF network, then the TWAN processor is further configured to:
ignore the 3GPP PCC QoS rule.

24. The BBF system of claim 22, further comprising:
a Broadband Policy Control Framework, BPCF, computer, the BPCF computer being configured to communicate with the TWAN computer, wherein the TWAN computer further includes
a TWAN transmitter in communication with the TWAN receiver and the TWAN processor, the TWAN transmitter configured to transmit the received 3GPP PCC QoS rule to the BPCF computer for one of verification and authorization of the 3GPP PCC QoS rule based on a BBF policy.

25. The BBF network system of claim 24, wherein the second type interface is an S9 interface, the TWAN computer is one of a Trusted Wireless Access Gateway, TWAG, computer and a Border Network Gateway Policy Enforcement Point, BNG/PEP computer, and wherein the BPCF computer includes:
a BPCF processor, the BPCF processor configured to verify the 3GPP PCC QoS rule based at least in part on the BBF policy; and
a BBF transmitter, the BBF transmitter configured to transmit to the TWAN computer at least one of an authorized 3GPP PCC QoS rule, event trigger and charging rule.
